(19) United States
(12) Patent Application Publication
(10) Pub. No.: US 2016/0373688 A1
(43) Pub. Date: Dec. 22, 2016

(54) NON-TRANSITORY COMPUTER-READABLE STORAGE MEDIUM, CODED DATA GENERATION METHOD AND CODED DATA GENERATION DEVICE

(71) Applicant: FUJITSU LIMITED, Kawasaki-shi (JP)

(72) Inventors: CHIKARA IMAJO, Fukuoka (JP); YASUO MISUDA, Inagi (JP)

(73) Assignee: FUJITSU LIMITED, Kawasaki-shi (JP)

(21) Appl. No.: 15/183,094

(22) Filed: Jun. 15, 2016

(30) Foreign Application Priority Data
Jun. 19, 2015 (JP) 2015-124221

(51) Int. Cl. H04N 7/01; H04N 19/169; H04N 19/107; H04N 19/136

(52) U.S. Cl. CPC H04N 7/0117; H04N 19/136; H04N 19/169; H04N 19/107

(57) ABSTRACT

A non-transitory computer readable storage medium that stores a coded data generation program that causes a computer to execute a process including obtaining a plurality of images, generated based on a same original image, having different resolutions, determining a specified configuration for coding a specified image that is one of the plurality of images, and coding each of the plurality of images by using the specified configuration.

### CROSS-REFERENCE TO RELATED APPLICATION

This application is based upon and claims the benefit of priority of the prior Japanese Patent Application No. 2015-124221, filed on Jun. 19, 2015, the entire contents of which are incorporated herein by reference.

### FIELD

The embodiment discussed herein is related to a non-transitory computer-readable storage medium, a coded data generation method, and a coded data generation device.

### BACKGROUND

As the resolution of display monitors has been increased in recent years, contents with various resolutions ranging from a large size, such as 8k size and 4k size, to a small size, such as a quarter VGA (QVGA) size, are viewed. Such contents are distributed to users by contents distributers and the like via the Internet and the like. As for the bandwidths of Internet lines used by users, some users use a broadband Internet line, while other users use a narrowband Internet line, and therefore, it is difficult to uniformly distribute contents at the same resolution to all of users.

Therefore, in general, the resolution of an image and the like are changed, image coding is performed at a plurality of resolutions, and thus, contents at a resolution suitable for each user is distributed. Also, a stream for distribution is prepared for each of images at a plurality of resolutions or each compression ratio.

FIG. 20 is a diagram illustrating a known coding device. A known coding device 10 generates pieces of image data having different resolutions, executes processing of encoding each of the pieces of image data in parallel, and generates streams. As illustrated in FIG. 20, the coding device 10 includes a resolution conversion processing section 11 and encoding sections 12, 13, and 14. The encoding section 12 includes a mode determination section 12a and an encoder 12b. The encoding section 13 includes a mode determination section 13a and an encoder 13b. The encoding section 14 includes a mode determination section 14a and an encoder 14b.

The resolution conversion processing section 11 is a processing section that acquires image data and generates pieces of image data having different resolutions. For example, the resolution conversion processing section 11 generates image data A1, image data A2, and image data A3. Assume that the magnitude relationship among respective resolutions of the image data A1, the image data A2, and the image data A3 is the resolution of the image data A1>the resolution of the image data A2>the resolution of the image data A3. The resolution conversion processing section 11 outputs the image data A1 to the encoding section 12. The resolution conversion processing section 11 outputs the image data A2 to the encoding section 13. The resolution conversion processing section 11 outputs the image data A3 to the encoding section 14.

The mode determination section 12a of the encoding section 12 is a processing section that predicts a coded image that is to be obtained by performing encoding using various types of mode information, specifies an encoding error of each coded image, and determines mode information that is expected to have a smallest encoding error. The mode determination section 12a outputs the determined mode information to the encoder 12b.

The encoder 12b of the encoding section 12 is a processing section that generates a stream by encoding the image data A1, based on the mode information that has been determined by the mode determination section 12a, and outputs the generated stream.

For the image data A2, the mode determination section 13a and the encoder 13b execute processing similar to processing of the mode determination section 12a and the encoder 12b and output a stream. For the image data A3, the mode determination section 14a and the encoder 14b execute processing similar to processing of the mode determination section 12a and the encoder 12b and output a stream.

### SUMMARY

According to an aspect of the invention, a non-transitory computer readable storage medium that stores a coded data generation program that causes a computer to execute a process including obtaining a plurality of images, generated based on a same original image, having different resolutions, determining a specified configuration for coding a specified image that is one of the plurality of images, and coding each of the plurality of images by using the specified configuration.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating CU division, PU division, and TU division;

FIG. 2 is a view illustrating an example of a plurality of prediction modes that belongs to an Intra prediction mode;

FIG. 3 is a diagram illustrating the concept of reference list and reference index;

FIG. 4 is another diagram illustrating the concept of reference list and reference index;

FIG. 5 is a functional block diagram illustrating a coded data generation device according to this embodiment;

FIG. 6 is a flow chart illustrating processing procedures of a mode conversion section according to this embodiment;

FIG. 7 is a diagram illustrating CU size changing processing and CU integration processing;

FIG. 8 is a diagram illustrating PU size changing processing and PU integration processing;

FIG. 9 is a diagram illustrating TU size changing processing and TU integration processing;

FIG. 10 is a flow chart illustrating processing procedures of PU integration processing;

FIG. 11 is a table supplementally illustrating processing of a mode conversion section;

FIG. 12 is another table supplementally illustrating processing of the mode conversion section;

FIG. 13 is a table supplementally illustrating motion vector integration processing;

FIG. 14 is another table supplementally illustrating motion vector integration processing;

FIG. 15 is a still another table supplementally illustrating motion vector integration processing;

FIG. 16 is a flow chart illustrating processing procedures of PU prediction mode integration processing;

FIG. 17 is a diagram illustrating another configuration of the coded data generation device;

FIG. 18 is a diagram illustrating other PU integration processing;

FIG. 19 is a diagram illustrating an example of a computer that executes a coded data generation program; and

FIG. 20 is a diagram illustrating a known coding device.

### DESCRIPTION OF EMBODIMENT

The above-described known technology has a problem in which the amount of computation is large.

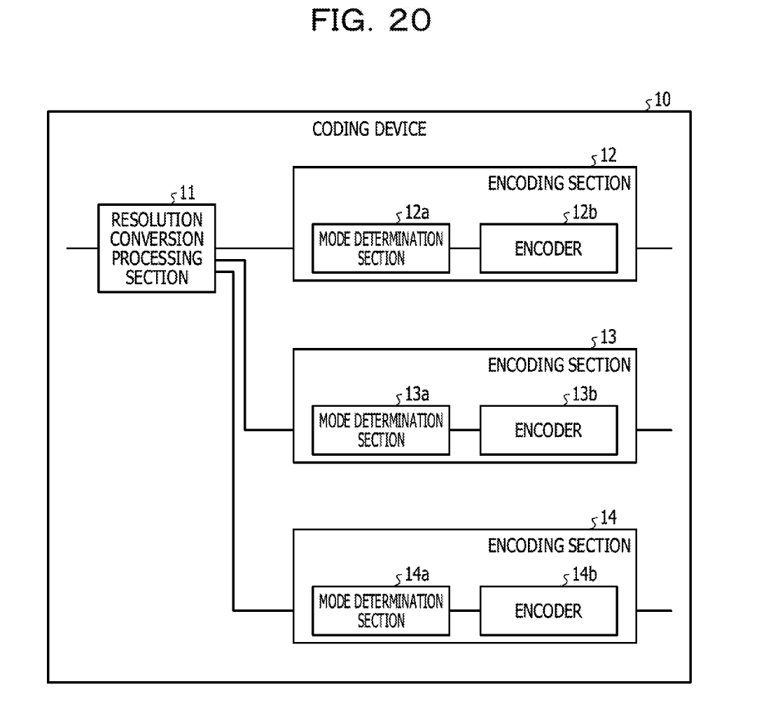

As illustrated in FIG. 20, the coding device 10 calculates suitable mode information for each of images having different resolutions, and therefore, when encoding is performed, a computing cost is increased.

According to one aspect, it is an object of the present disclosure to reduce the amount of computation in coded data generation.

An embodiment for a coded data generation program, a coded data generation method, and a coded data generation device disclosed in the present disclosure will be described in detail below with reference to the accompanying drawings. Note that the present disclosure is not limited to the following embodiment.

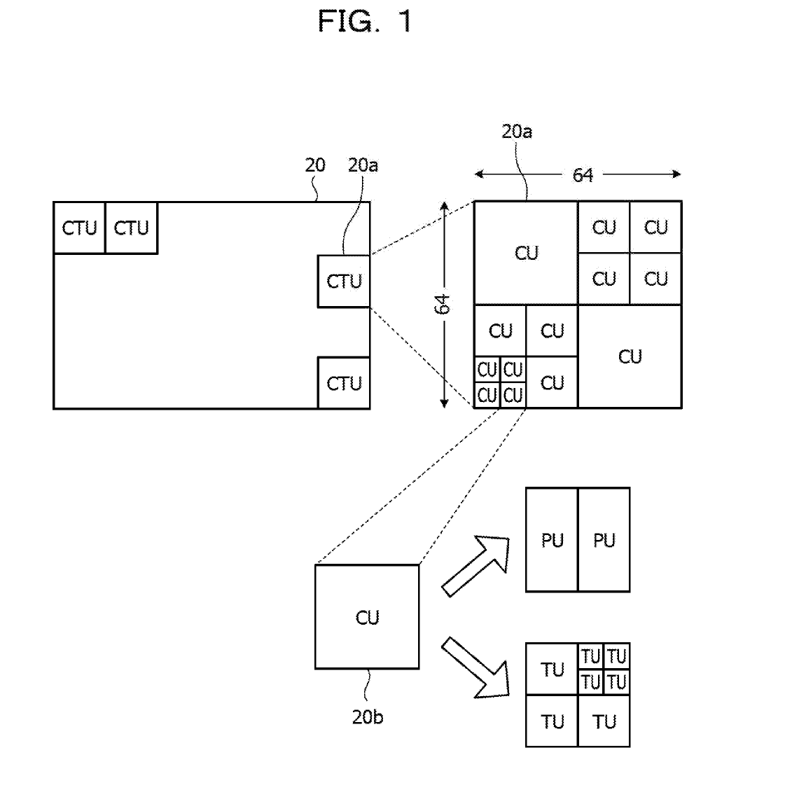

Before describing a coded data generation device according to this embodiment, mode information will be described. For example, for mode information, there are several elements defined by the high efficiency video coding (HEVC) standard. In the HEVC coding system, a processing unit, that is, a coding tree block (CTU), for image coding may be freely divided. As for division units, there are coding unit (CU) division, prediction unit (PU) division, and transform unit (TU) division. FIG. 1 is a diagram illustrating CU division, PU division, and TU division. As illustrated in FIG. 1, an image 20 is divided by a plurality of CTUs.

CU division is division of a CTU in CU units. A CU represents a coding control unit. A CU has a quadtree structure. The size of a CU is 4×4 to 64×64. FIG. 1 illustrates, as an example, how a CTU 20a is divided into CUs having different sizes. PU and TU are division sizes that are equal to or smaller than the CU unit.

PU division is division of a CU in PU units. A PU represents a unit of prediction processing. The size of a PU is, for example, 2N×2N, 2N×N, N×N, and N×2N. FIG. 1 illustrates, as an example, how a CU 20b is divided into two PUs.

TU division is division of a CU in TU units. A TU represents a unit of frequency conversion. A TU has a quadtree structure. The size of a TU is, for example, 4×4 to 64×64. FIG. 1 illustrates, as an example, how a CU 20b is divided into TUs having different sizes.

For the above-described PU, several pieces of mode information may be designated. Mode information has an Intra prediction mode and an Inter prediction mode. Furthermore, each of the Intra prediction mode and the Inter prediction mode may be subdivided into a plurality of prediction modes.

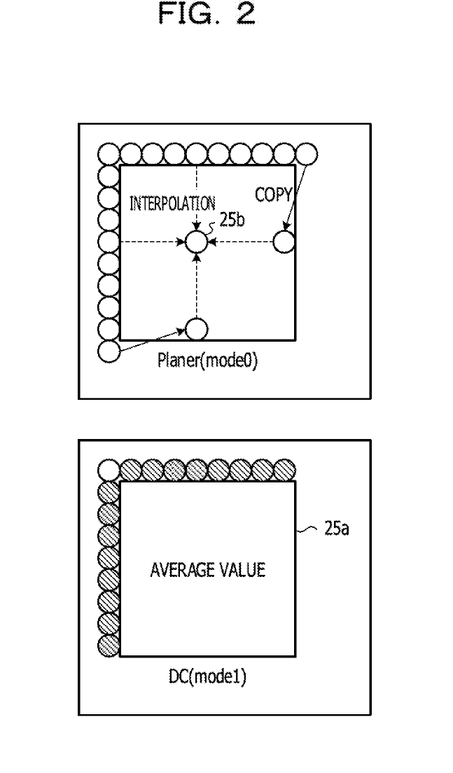

The Intra prediction mode will be described. FIG. 2 is a view illustrating an example of a plurality of prediction modes that belong to an Intra prediction mode. The Intra prediction mode is a mode in which the pixel value in a corresponding position from spatially neighboring pixels that exist on the same image is predicted. For example, examples of the Intra prediction mode include a DC mode and a Planer mode. The DC mode is a mode in which the pixel value of a certain block, that is, a block 25a, is predicted from an average value for a peripheral image. The Planer mode is a mode in which a pixel value in a position 25b is predicted, based on a weighted average of peripheral pixels corresponding to the position 25b.

The Inter prediction mode will be described. The Inter prediction mode is a mode in which a pixel value in a corresponding position is predicted, based on a reference picture that is to be another image. Examples of the Inter prediction mode include L0, L1, Bi, Merg, and Skip.

L0 is a prediction mode in which only a reference list L0 is used. In L0, a single reference picture may be referred to using a reference index. The reference list and the reference index will be described later.

L1 is a prediction mode in which only a reference list L1 is used. In L1, a single reference picture may be referred to using the reference index.

Bi is a prediction mode in which the reference lists L0 and L1 are used. In Bi, a single reference picture in each of the lists may be referred to using the reference index.

Merg is a prediction mode in which the same list, the same reference index, and the same prediction vector as those of one of the peripheral PUs are used.

Skip is a prediction mode which is used when Merg or a vector matches the corresponding one of those of AMVP and there is no difference coefficient, and in which prediction in a certain position is skipped. AMVP corresponds to a prediction vector that a peripheral PU has.

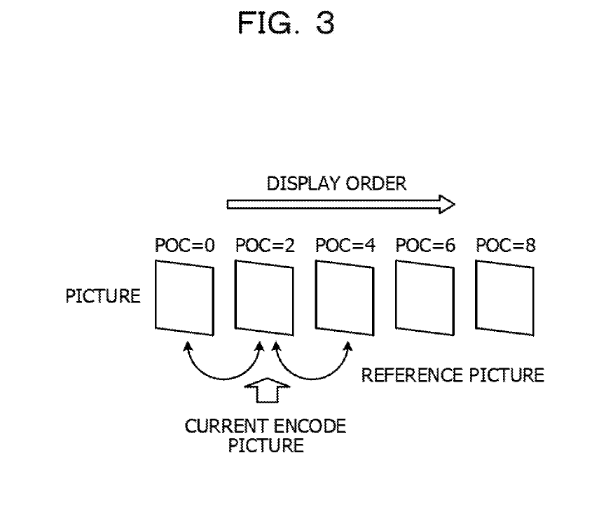

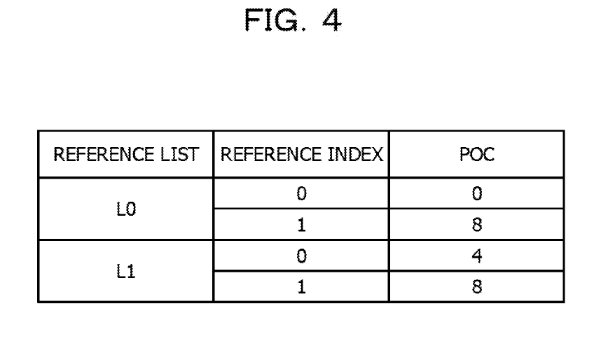

Subsequently, the concept of the concept of reference list and reference index will be described. Each of FIG. 3 and FIG. 4 is a diagram illustrating the concept of reference list and reference index. In the HEVC standard, a reference picture is managed using a reference list and a reference index. With respect to a current encode picture, other pictures are considered as reference pictures, and are used as reference pictures of the Inter prediction mode. As illustrated in FIG. 3, a picture order count (POC) is given to each of the current encode picture and the reference pictures. The POC is a number uniquely indicting the order in which pictures area displayed.

Pictures that are used as the reference pictures for the current encode picture are managed using a list associated with a reference list and a reference index of L0 and L1, and an example of the list is illustrated in FIG. 4. In FIG. 4, for example, if a reference picture, the reference list of which is “L0”, and the reference index of which is “0”, is designated, it is known, by referring to the list, that the reference picture is a picture the POC of which is “0”.

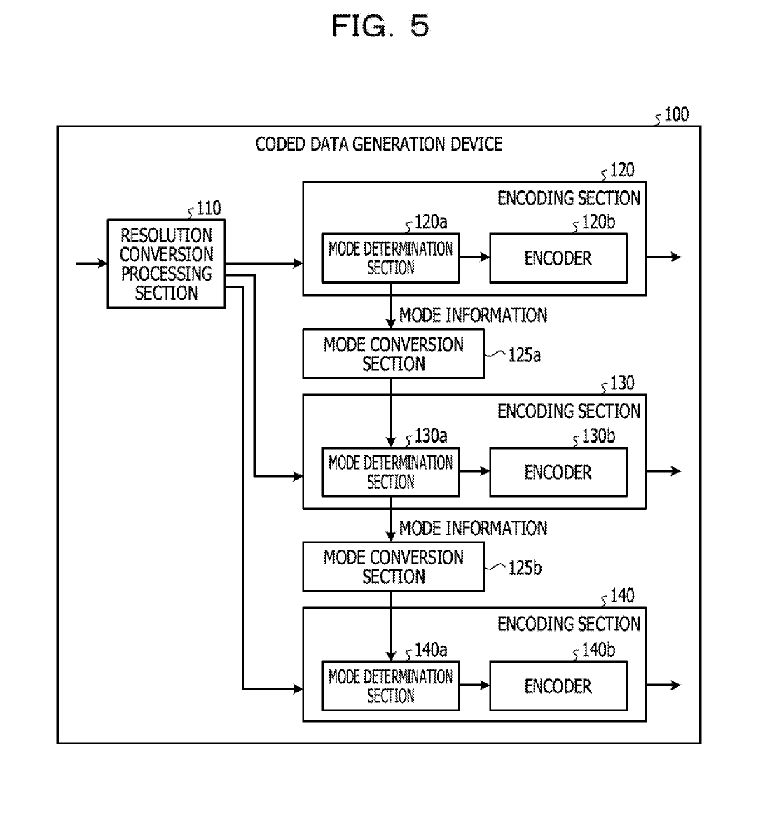

Next, an example of a configuration of a coded data generation device according to this embodiment will be described. FIG. 5 is a functional block diagram illustrating a coded data generation device according to this embodiment. As illustrated in FIG. 5, a coded data generation device 100 includes a resolution conversion processing section 110, encoding sections 120, 130, and 140, and mode conversion sections 125a and 125b. For example, the encoding section 120 corresponds to a first encoding section. The mode conversion section 125a and the encoding section 130 correspond to a second encoding section.

The resolution conversion processing section 110 is a processing section acquires image data from an external device (not illustrated) and generates a plurality of pieces of image data having different resolutions. For example, the resolution conversion processing section 110 generates image data A1, image data A2, and image data A3. Assume that the magnitude relationship among respective resolutions of the image data A1, the image data A2, and the image data A3 is the resolution of the image data A1>the resolution of the image data A2>the resolution of the image data A3. The resolution conversion processing section 110 outputs the image data A1 to the encoding section 120. The resolution conversion processing section 110 outputs the image data A2 to the encoding section 130. The resolution conversion processing section 110 outputs the image data A3 to the encoding section 140.

The encoding section 120 includes a mode determination section 120a and an encoder 120b. The mode determination section 120a is a processing section that predicts a coded image that is to be obtained by performing encoding using various types of mode information, specifies an encoding error of each coded data, and determines mode information that is expected to have a smallest encoding error. The mode determination section 120a outputs the determined mode information to the encoder 120b and a mode conversion section 125a.

The encoder 120b is a processing section that generates a stream by encoding the image data A1, based on the mode information that has been determined by the mode determination section 120a, and outputs the generated stream.

The mode conversion section 125a is a processing section that acquires mode information when the image data A1 is encoded from the mode determination section 120a and performs conversion to mode information when the image data A2 is encoded, based on the acquired mode information. The mode conversion section 125a outputs the converted mode information to the encoding section 130.

The encoding section 130 includes a mode determination section 130a and an encoder 130b. The mode determination section 130a is a processing section that determines the mode information that has been acquired from the mode conversion section 125a as mode information when the image data A2 is encoded. The mode determination section 130a outputs the determined mode information to the encoder 130b and the mode conversion section 125b.

The encoder 130b is a processing section that generates a stream by encoding the image data A2, based on the mode information that has been determined by the mode determination section 130a, and outputs the generated stream.

The mode conversion section 125b is a processing section that acquires mode information when the image data A2 is encoded from the mode determination section 130a and performs conversion to mode information when the image data A3 is encoded, based on the acquired mode information. The mode conversion section 125b outputs the converted mode information to the encoding section 140.

The encoding section 140 includes a mode determination section 140a and an encoder 140b. The mode determination section 140a is a processing section that determines the mode information that has been acquired from the mode conversion section 125b as mode information when the image data A3 is encoded. The mode determination section 140a outputs the determined mode information to the encoder 140b.

The encoder 140b is a processing section that generates a stream by encoding the image data A3, based on the mode information that has been determined by the mode determination section 140a, and outputs the generated stream.

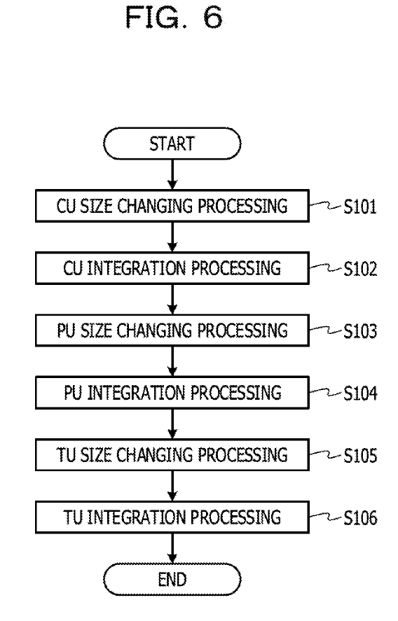

Next, processing of the mode conversion section 125a illustrated in FIG. 5 will be described. Processing of the mode conversion section 125b is similar to the processing of the mode conversion section 125a. FIG. 6 is a flow chart illustrating processing procedures of a mode conversion section according to this embodiment.

As illustrated in FIG. 6, the mode conversion section 125a performs CU size changing processing (Step S101), performs CU integration processing (Step S102), and performs PU size changing processing (Step S103).

Subsequently, the mode conversion section 125a performs PU integration processing (Step S104), performs TU size chancing processing (Step S105), and performs TU integration processing (Step S106).

Next, processing of S101 to S106 that is executed by the mode conversion section 125a illustrated in FIG. 6 will be described using an example. As an example, the resolution of the image data A2 is one half of the resolution of the image data A1. That is, each of the ratio between respective horizontal widths of image data of a service provider and current image data and the ratio between respective vertical widths of the image data and the current image data is 2:1.

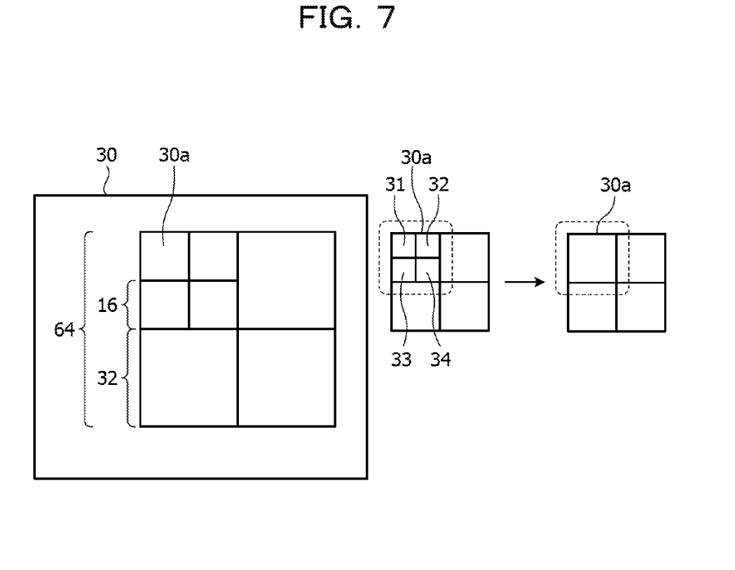

CU size changing processing of Step S101 and CU integration processing of Step S102 will be described. FIG. 7 is a diagram illustrating CU size changing processing and CU integration processing. The mode conversion section 125a changes a CU size, based on CU division information included in mode information derived at the resolution of the image data A1 and the resolution of the image data A2.

For example, the CU division information of the mode information derived at the resolution of image data A1 is indicated in CU division information 30 of FIG. 7. In the CU division information 30, the sizes of CUs are 32×32 and 16×16. Using a CU 30a having a size of 16×16, the following description will be given.

When the mode conversion section 125a changes the size of the CU 30a such that a division size is one half of the original size, the CU 30a is divided into CUs 31 to 34 and the size of each of the CUs 31 to 34 is 8×8.

There are cases where, when the mode conversion section 125a changes the size of CUs, the size of CUs after the change is operationally not allowable. As an example, assume that the unallowable CU size is 8×8 or smaller. Thus, the size of the CUs 31 to 34 in FIG. 7 is an unallowable size. In this case, the mode conversion section 125a integrates the four CUs 31 to 34 that are adjacent to one another to achieve the CU 30a having an allowable CU size of 16×16.

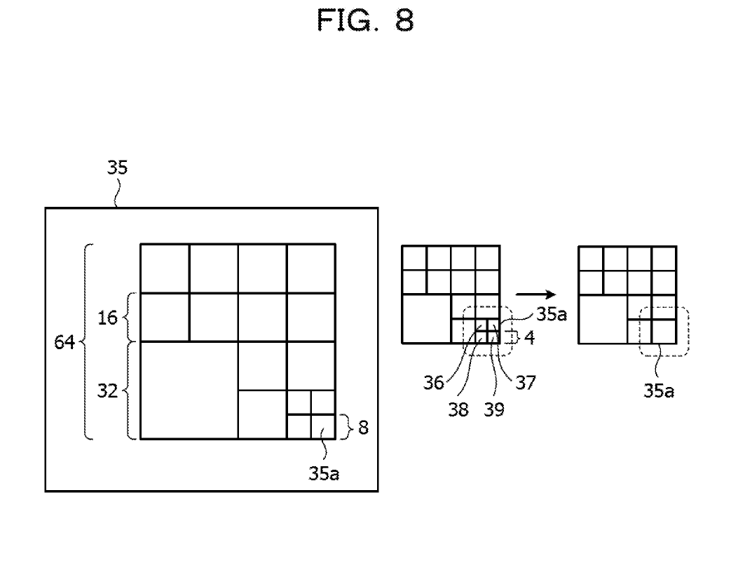

PU size changing processing of Step S103 and PU integration processing of Step S104 will be described. FIG. 8 is a diagram illustrating PU size changing processing and PU integration processing. The mode conversion section 125a changes a PU size, based on PU division information included in the mode information derived at the resolution of image data A1 and the resolution of the image data A2.

For example, the PU division information of the mode information derived at the resolution of the image data A1 is indicated in PU division information 35 of FIG. 8. In the PU division information 35, the sizes of PUs are 32×32, 16×16, and 8×8. Using a PU 35a having a size of 8×8, the following description will be given.

When the mode conversion section 125a changes the size of the PU 35a such that a division size is one half of the original size, the PU 35a is divided into PUs 36 to 39 and the size of the PUs 36 to 39 is 4×4.

There are cases where, when the mode conversion section 125a changes the size of PUs, the size of PUs after the change is operationally not allowable. As an example, assume that the unallowable PU size is 4×4 or smaller. Thus, the size of the PUs 36 to 39 in FIG. 8 is an unallowable size. In this case, the mode conversion section 125a integrates the four PUs 36 to 39 that are adjacent to one another to achieve the PU 35a having an allowable PU size of 8×8.

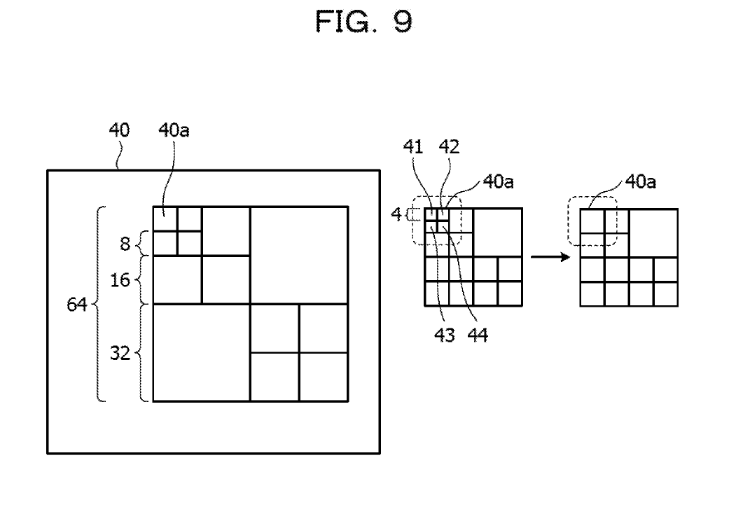

TU size changing processing of Step S105 and TU integration processing of Step S106 will be described. FIG. 9 is a diagram illustrating TU size changing processing and TU integration processing. The mode conversion section 125a changes a TU size, based on TU division information included in mode information derived at the resolution of the image data A1 and the resolution of the image data A2.

For example, the TU division information of the mode information derived at the resolution of the image data A1 is indicated in TU division information 40 of FIG. 9. In the TU division information 40, the sizes of TUs are 64×64, 32×32, 16×16, and 8×8. Using a TU 40a having a size of 8×8, the following description will be given.

When the mode conversion section 125a changes the size of the TU 40a such that a division size is one half of the original size, the TU 40a is divided into TUs 41 to 44 and the size of the TUs 41 to 44 is 4×4.

There are cases where, when the mode conversion section 125a changes the size of TUs, the size after the change is operationally not allowable. As an example, assume that the unallowable TU size is 4×4 or smaller. Thus, the size of the TUs 41 to 44 in FIG. 9 is an unallowable size. In this case, the mode conversion section 125a integrates the four TUs 41 to 44 that are adjacent to one another to achieve the TU 40a having an allowable TU size of 8×8.

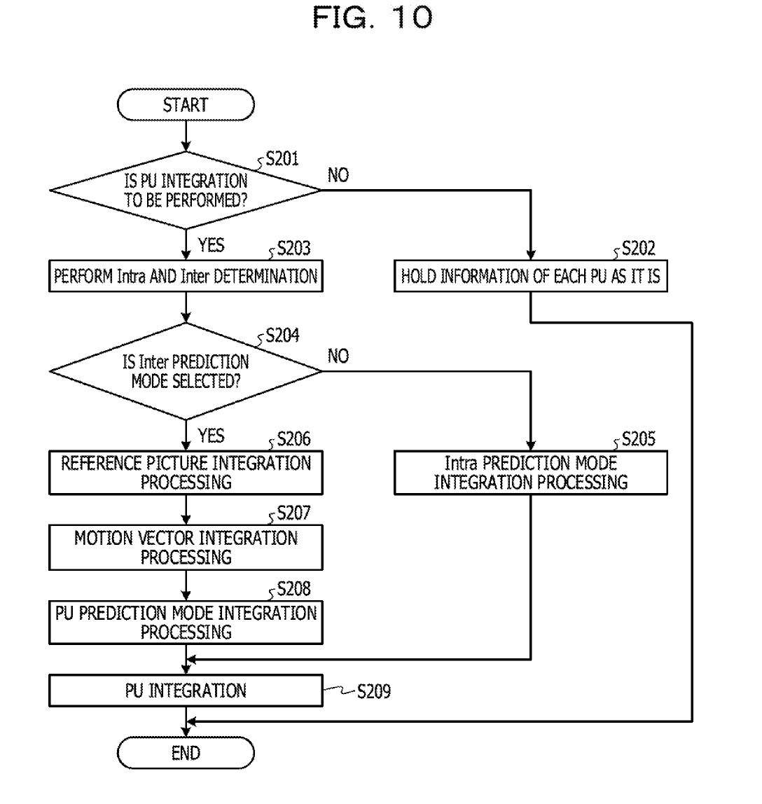

Next, the PU integration processing indicated in Step S104 of FIG. 6 will be specifically described. FIG. 10 is a flow chart illustrating processing procedures of PU integration processing. As illustrated in FIG. 10, the mode conversion section 125a determines whether or not PU integration is to be performed (Step S201). If the mode conversion section 125a performs PU integration (YES in Step S201), the mode conversion section 125a causes the process to proceed to Step S203.

On the other hand, if the mode conversion section 125a does not perform PU integration (NO in Step S201), the mode conversion section 125a holds information of each PU as it is (Step S202). For example, in Step S202, a difference between an Intra prediction mode and an Inter prediction mode set in each PU and information of a reference index in the Inter prediction mode are caused to remain as they are. Also, for information of a vector set for the PU, the mode conversion section 125a performs scaling in accordance with a difference in the resolution.

The mode conversion section 125a performs Intra and Inter determination (Step S203). If the mode conversion section 125a selects the Inter prediction mode (YES in Step S204), the mode conversion section 125a causes the process to proceed to Step S206. If the mode conversion section 125a does not select the Inter prediction mode (NO in Step S204), the mode conversion section 125a causes the process to proceed to Step S205.

The mode conversion section 125a executes Intra prediction mode integration processing (Step S205), and causes the process to proceed to Step S209.

The mode conversion section 125a executes reference picture integration processing (Step S206). The mode conversion section 125a executes motion vector integration processing (Step S207). The mode conversion section 125a executes PU prediction mode integration processing (Step S208). The mode conversion section 125a performs PU integration (Step S209).

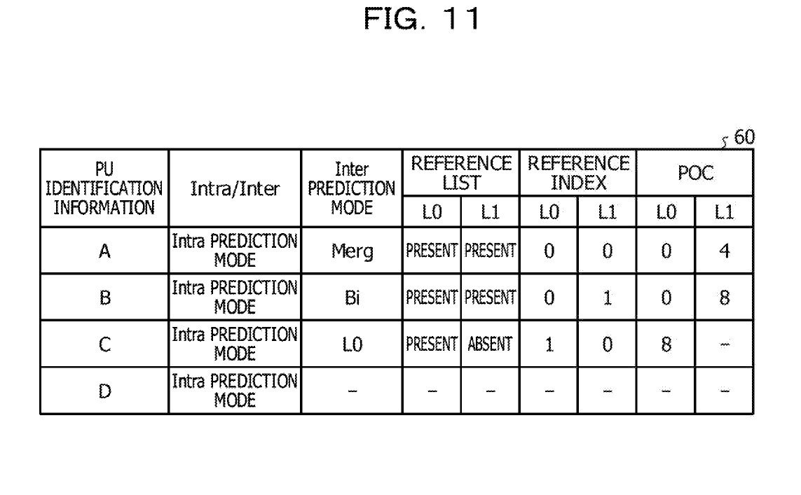

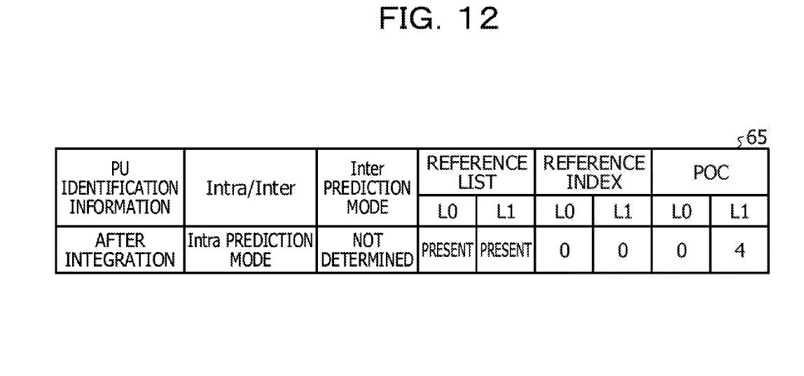

Next, each processing illustrated in FIG. 10 will be supplementally described. Each of FIG. 11 and FIG. 12 is a table supplementally illustrating processing of the mode conversion section. For example, a table 60 of FIG. 11 illustrates mode information set for a PU that is an integration target. The table 60 includes PU identification information, Intra/Inter, an Inter prediction mode, a reference list, a reference index, and a reference picture POC number.

The PU identification information is information that uniquely identifies a PU that is an integration target. Intra/Inter is information that identifies whether a prediction mode set for the PU is the Inter prediction mode or the Intra prediction mode. The Inter prediction mode indicates a specific content of the Inter prediction mode. As described above, the Inter prediction mode is one of L0, L1, Bi, Merg, and Skip. The description of each of the reference list, the reference index, and the POC is similar to the description of each of the reference list, the reference index, and the POC illustrated in FIG. 4.

For example, mode information set for the PU identification information “B” will be described. A prediction mode set for the PU “B” is the “Inter prediction mode”, and a specific Inter prediction mode is “Bi”. If the reference index is “0”, it is indicated that the reference picture is a picture the POC of which is “0”. If the reference index is “1”, it is indicated that the reference picture is a picture the POC of which is “8”.

For example, when the mode conversion section 125a executes processing illustrated in FIG. 10 and integrates mode information of PUs “A and B” illustrated in FIG. 11, mode information of an integrated PU is information indicated in a table 65 illustrated in FIG. 12.

Processing of determining whether or not the PU integration indicated in Step S201 is to be performed will be described. As illustrated in FIG. 8, the mode conversion section 125a divides a TU and determines, if the size of each divided TU is operationally not allowable, to integrate each divided TU.

Intra and Inter determination indicated in Step S203 will be described. The mode conversion section 125a counts the number of PUs for which the Intra prediction mode has been selected and the number of PUs for which the Inter prediction mode has been selected. If the number of PUs for which the Intra prediction mode has been selected is equal to or larger than the number of PUs for which the Inter prediction mode has been selected, the mode conversion section 125a determines that the prediction mode of an integrated PU is “the Intra prediction mode”. On the other hand, if the number of PUs for which the Intra prediction mode has been selected is smaller than the number of PUs for which the Inter prediction mode has been selected, the mode conversion section 125a determines the prediction mode of the integrated PU as “the Inter prediction mode”.

For example, in the example of the table 60 illustrated in FIG. 11, the number of PUs for which the Intra prediction mode has been selected is smaller than the number of PUs for which the Inter prediction mode has been selected. Therefore, the mode conversion section 125a determines the prediction mode of the integrated PU as “the Inter prediction mode”.

Note that the mode conversion section 125a may perform Intra and Inter determination, based on another criteria. The mode conversion section 125a compares the total area of PUs for which the Intra prediction mode has been selected and the total area of PUs for which the Inter prediction mode has been selected to each other and determines one of the prediction modes, the total area of which is larger than that of the other one, as the prediction mode of the integrated PU. Furthermore, as long as information of a determination index at the resolution set by a service provider of mode information may be obtained, the mode conversion section 125a may select a prediction mode that causes a determination index to be the best.

Reference picture integration processing illustrated in Step S206 will be described. The reference picture is a reference image used for inter-screen prediction designated by a reference list and a reference index. There are cases where the same reference picture is registered in the reference lists L0 and L1. Therefore, the mode conversion section 125a determines once, based on the reference list and the reference index of each PU, which reference picture is referred to. The mode conversion section 125a selects the reference list and the reference index of the integrated PU, based on a result of determination on which reference picture each PU refers to.

In this case, reference picture integration processing targets of which are PUs “A to D” illustrated in FIG. 11 will be described. In this case, because the PU “D” is “the Intra prediction mode”, there are not the reference lists L0 and L1, and therefore, the mode conversion section 125a excludes the PU “D” from the determination targets.

For example, the mode conversion section 125a selects a reference picture that is set for the integrated PU, based on a first rule, a second rule, and a third rule, which will be described blow.

The first rule is a rule under which a reference picture the number of which is the largest is selected.

The second rule is a rule under which, if there is a plurality of reference pictures the number of which is the largest, a reference picture the POC of which is the closest to the POC of image data that is currently encoded.

The third rule is a rule under which, if a reference picture is not set for all of PUs that are to be integration targets, there is no reference picture that corresponds to the integrated PU.

Incidentally, although it is assumed that the first rule is a rule under which a reference picture the number of which is the largest is selected, the first rule may be a rule under which a reference picture the area of which is the largest is selected.

When the mode conversion section 125a selects a reference picture, based on the first rule to the third rule, the mode conversion section 125a selects a picture the POC of which is “0” for the reference list L0, and selects a picture the POC of which is “4” for the reference list L1. The reference list, the reference index, and the POC for the integrated PU are as illustrated in FIG. 12.

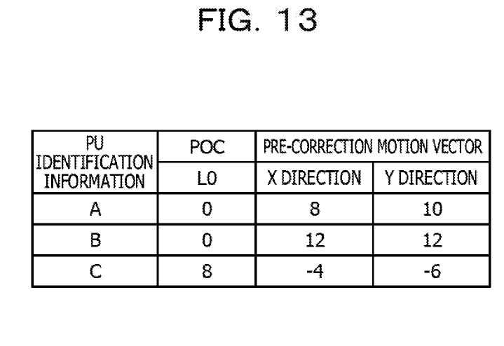

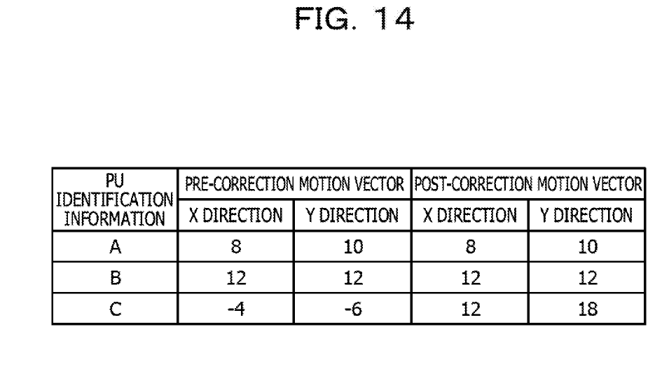

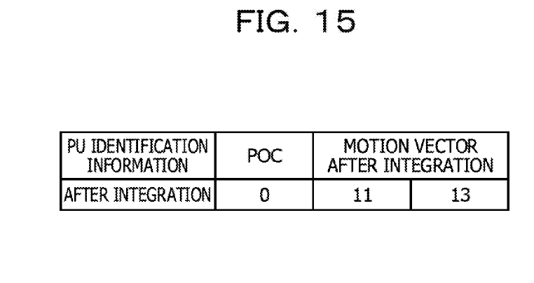

Motion vector integration processing illustrated in Step S207 will be described. Each of FIG. 13, FIG. 14, and FIG. 15 is a table supplementally illustrating motion vector integration processing. In an example illustrated in FIG. 13, there are three motion vectors in the reference list L0 side. For example, as illustrated in FIG. 13, it is assumed that the reference picture of the PU “A” is the picture the POC of which is “0” and the X direction and the Y direction of a pre-correction motion vectors of the PU “A” are “8” and “10”, respectively. It is assumed that the reference picture of the PU “B” is the picture the POC of which is “0” and the X direction and the Y direction of a pre-correction motion vector of the PU “B” are “12” and “12”, respectively. It is assumed that the reference picture of the PU “C” is the picture the POC of which is “8” and the X direction and the Y direction of a pre-correction motion vectors of the PU “C” are “−4” and “−6”, respectively.

The mode conversion section 125a calculates the post-correction motion vector of each PU, based on following Formula (1) and Formula (2).

X=x×(PrePOC−CrntPOC)/(PostPOC−CrntPOC) (1)

Y =y×(PrePOC−CrntPOC)/(PostPOC−CrntPOC) (2)

In Formula (1) and Formula (2), X denotes a vector in the X direction after correction and Y denotes a vector in the Y direction after correction. Also, x denotes a vector in the X direction before correction and y denotes a vector in the Y direction before correction. CrntPOC denotes the POC of image data that is currently encoded. PrePOC denotes the POC of a reference picture before correction. PostPOC denotes the POC of a reference picture after correction (after integration). The POC of a reference picture after integration is determined by the above-described reference picture integration processing.

When the mode conversion section 125a calculates respective post-correction motion vectors of the PUs “A to C”, based on Formula (1) and Formula (2), results are as illustrated in FIG. 14. On the left side of FIG. 14, pre-correction vectors x and y in the X direction and the Y direction before correction are indicated. On the right side of FIG. 14, post-correction vectors X and Y in the X direction and the Y direction after correction are indicated. For example, the calculation results illustrated in FIG. 14 are calculation results when it is assumed that CrntPOC is “2”.

The mode conversion section 125a calculates a motion vector of the integrated PU by averaging each of the post-correction motion vectors X and Y of the PUs “A to C”. The mode conversion section 125a may perform rounding processing, such as rounding off and the like, for a broken number. In an example illustrated in FIG. 15, of post-integration motion vectors in the reference list L0 side, a vector in the X direction is “11” and a vector in the Y direction is “13”. Also, the POC of a reference picture in the reference list L0 side after integration is “0”.

PU prediction mode integration processing illustrated in Step S208 will be described. The mode conversion section 125a determines an Inter prediction mode after integration, based on a fourth rule, a fifth rule, a sixth rule, and a seventh rule.

Under the fourth rule, if there is a reference picture in each of the reference lists L0 and L1 and the reference pictures therein are different from each other, “Bi” is selected.

Under the fifth rule, if, while there is a reference picture in the reference list L0, there is no reference picture in the reference list L1, “L0” is selected. As another option, if there is a reference picture in each of the reference lists L0 and L1 but the same reference picture is referred to, “L0” is selected.

Under the sixth rule, if, under a condition in which the fourth rule or the fifth rule is not satisfied, there is a reference picture in the reference list L1, “L1” is selected.

Under the seventh rule, if, even when the fourth rule, the fifth rule, and the sixth rule are satisfied, Merg is selectable, Merg is selected.

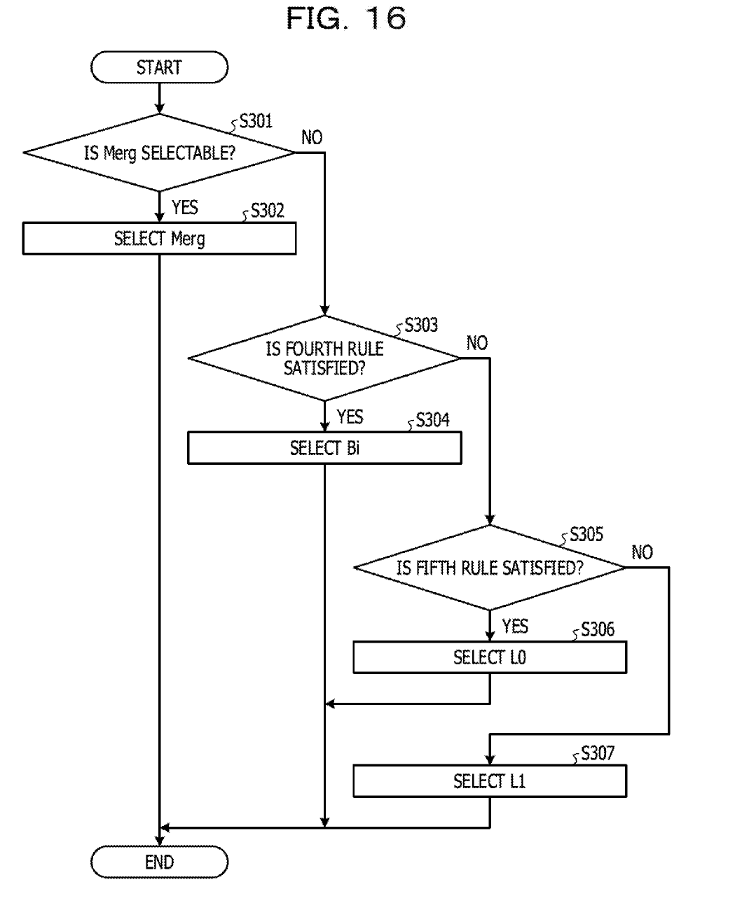

Next, processing procedures of PU prediction mode integration processing illustrated in Step S208 will be described. FIG. 16 is a flow chart illustrating processing procedures of the PU prediction mode integration processing. As illustrated in FIG. 16, the mode conversion section 125a determines whether or not Merg is selectable (Step S301). If Merg is selectable (YES in Step S301), the mode conversion section 125a selects Merg as the Inter prediction mode. If Merg is not selectable (NO in Step S301), the mode conversion section 125a causes the process to proceed to Step S303.

The mode conversion section 125a determines whether or not the fourth rule is satisfied (Step S303). If the fourth rule is satisfied (YES in Step S303), the mode conversion section 125a selects Bi as the Inter prediction mode (Step S304). If the fourth rule is not satisfied (NO in Step S303), the mode conversion section 125a causes the process to proceed to Step S305.

The mode conversion section 125a determines whether or not the fifth rule is satisfied (Step S305). If the fifth rule is satisfied (YES in Step S305), the mode conversion section 125a selects L0 as the Inter prediction mode (Step S306).

If the fifth rule is not satisfied (NO in Step S305), the mode conversion section 125a selects L1 as the Inter prediction mode (Step S307). In Step S307, if the fourth rule and the fifth rule are not satisfied, the sixth rule is satisfied, and therefore, the mode conversion section 125a selects L1 as the Inter prediction mode.

Incidentally, in Step S302, if the mode conversion section 125a selects Merg, no difference coefficient is generated in the Merg mode, and the motion vector matches that of AMVP, the mode conversion section 125a selects Skip as the Inter prediction mode.

Intra prediction mode integration processing illustrated in Step S205 will be described. The mode conversion section 125a determines the Intra prediction mode after integration, based on an eighth rule, a ninth rule, and a tenth rule.

Under the eighth rule, if there is a DC in the Intra prediction mode before integration, the Intra prediction mode after integration is “DC”.

Under the ninth rule, if there is no DC in the Intra prediction mode before integration but there is Plane, the Intra prediction mode after integration is “Plane”.

Under the tenth rule, if there is no DC and Plane in the Intra prediction mode before integration, a prediction mode in which an average direction of prediction directions of the Intra prediction mode that were selected before integration is set.

Next, advantages of the coded data generation device 100 according to this embodiment will be described. The encoding section 120 of the coded data generation device 100 performs encoding processing on image data having the highest resolution to generate coded data. The encoding section 130 performs processing of generating a plurality of pieces of coded data other than the coded data having the highest resolution, based on mode information used in processing of generating the coded data having the highest resolution. Therefore, the encoding section 130 of the coded data generation device 100 performs encoding using mode information generated by the encoding section 120, and thus, the amount of computation performed in generating mode information may be reduced. The encoding section 140 performs encoding using mode information used by the encoding section 130, and therefore, the amount of computation performed in generating mode information may be reduced.

The mode conversion section 125a of the coded data generation device 100 integrates pieces of mode information set in PUs that correspond to the coded data having the highest resolution to generate mode information that is used in the encoding section 130. Therefore, as compared to a case where mode information is generated initially, the amount of computation performed in generating mode information may be reduced. For the mode conversion section 125b, the amount of computation may be reduced in a similar manner.

When the mode conversion section 125a integrates mode information, the mode conversion section 125a determines, based on the number or the area of PUs for which the Intra prediction mode has been selected and on the number or the area of PUs for which the Inter prediction mode has been selected, a prediction mode designated by the mode information before integration. Therefore, based on a simple determination criteria, mode information of image data that is an encoding target may be specified.

If reference pictures set in pieces of mode information are different from each other, the mode conversion section 125a selects a reference picture that is the closest to image data that is an encoding target and sets the reference picture in supplementary information after integration. Therefore, an appropriate reference picture may be set in mode information.

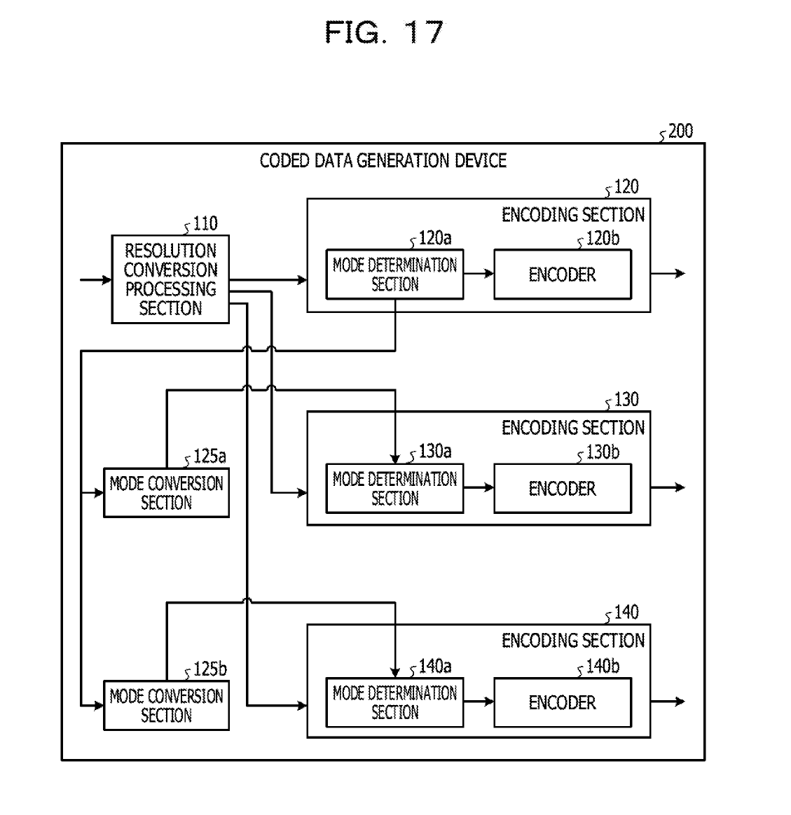

Incidentally, in the coded data generation device 100 illustrated in FIG. 5, the mode conversion sections 125a and 125b are coupled in series, but coupling of the mode conversion sections 125a and 125b is not limited thereto. FIG. 17 is a diagram illustrating another configuration of the coded data generation device.

A coded data generation device 200 includes a resolution conversion processing section 110, encoding sections 120, 130, and 140, and mode conversion sections 125a and 125b. The description of each of the resolution conversion processing section 110 and the encoding sections 120, 130, and 140 is similar to the description of each of the resolution conversion processing section 110 and the encoding sections 120, 130, and 140 illustrated in FIG. 5.

As illustrated in FIG. 17, the mode conversion sections 125a and 125b are coupled in parallel. The mode conversion section 125a acquires mode information when image data A1 is encoded from a mode determination section 120a and performs conversion to mode information when image data A2 is encoded, based on the acquired mode information. The mode conversion section 125a outputs the converted mode information to the encoding section 130.

The mode conversion section 125b acquires mode information when the image data A1 is encoded from the mode determination section 120a and performs conversion to mode information when image data A3 is encoded, based on the acquired mode information. The mode conversion section 125b outputs the converted mode information to the encoding section 140.

In the configuration illustrated in FIG. 17, pieces of mode information used by the encoding sections 130 and 140 are generated in parallel from mode information generated by the encoding section 120. Therefore, as compared to a case where mode information is generated in many stages, as in the configuration illustrated in FIG. 5, time which it takes to complete encoding for all of streams may be reduced.

Note that the above-described PU integration processing is an example, and other PU integration processing will be described below. In the above-described PU integration processing, there are cases where, when a resolution is low, an appropriate PU division result is not achieved.

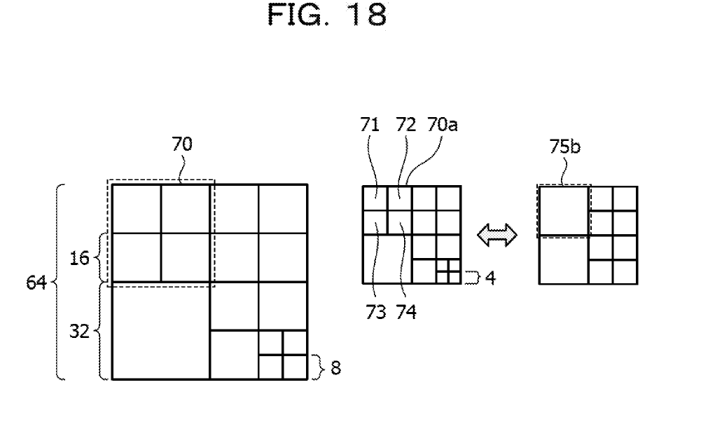

FIG. 18 is a diagram illustrating other PU integration processing. For example, when the mode conversion section 125a divides each PU of an area 70, based on PU division information and a current resolution, PUs 71 to 74 illustrated in an area 70a are achieved. The mode conversion section 125a applies the corresponding motion vector, reference index, and Intra prediction mode from mode information of each PU set in the area 70 to a motion vector, a reference index, and an Intra prediction mode in the mode information set for each of the PUs 71 to 74 of the area 70a.

When the mode conversion section 125a integrates the PUs 71 to 74 in the area 70 by executing the processing illustrated in FIG. 10, a PU 75b is achieved and mode information set for the PU 75b is information in accordance with a result of processing of FIG. 10.

In this case, the mode conversion section 125a compares a first encoding error when encoding is performed using pieces of mode information of the PUs 71 to 74 and a second encoding error when encoding is performed using mode information of the PU 75b to each other. If the first encoding error is smaller than the second encoding error, the mode conversion section 125a employs the pieces of mode information of the PUs 71 to 74. On the other hand, if the second encoding error is smaller than the first encoding error, the mode conversion section 125a employs the mode information of the PU 75b. The above-described processing is executed, and thereby, encoding may be executed using mode information with a smaller encoding error.

Note that, when the mode conversion section 125a performs CU integration processing and TU integration processing in a similar manner to a manner in which PU integration processing is performed, the mode conversion section 125a may evaluate encoding errors, select integration with a smaller encoding error, and thus, CU integration processing and TU integration processing may be executed.

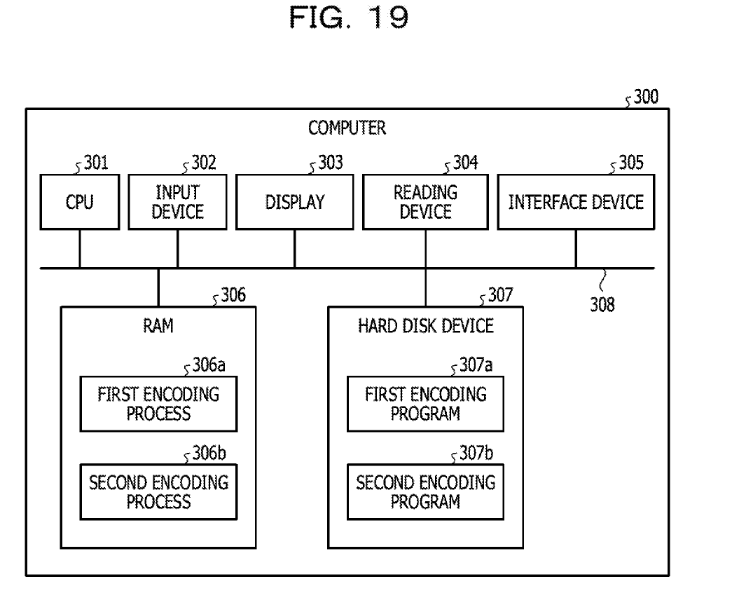

Next, an example of a computer that executes a coded data generation program that realizes a similar function to those of the coded data generation devices 100 and 200 described in the above-described embodiment will be described. FIG. 19 is a diagram illustrating an example of a computer that executes a coded data generation program.

As illustrated in FIG. 19, a computer 300 includes a CPU 301 that executes each arithmetic processing, an input device 302 that receives an input of data from a user, and a display 303. Also, the computer 300 includes a reading device 304 that reads a program and the like from a storage medium and an interface device 305 that receives and transmits data with another computer via a network. Also, the computer 300 includes a RAM 306 that temporarily stores various types of information and a hard disk device 307. Each of the devices 301 to 307 is coupled to a bus 308.

The hard disk device 307 reads a first encoding program 307a and a second encoding program 307b and develops them to the RAM 306. The first encoding program 307a functions as a first encoding process 306a. The second encoding program 307b functions as a second encoding process 306b. For example, the first encoding process 306a corresponds to the encoding section 120. The second encoding process 306b corresponds to the mode conversion section 125a and the encoding section 130.

Note that there may be cases where the first encoding program 307a and the second encoding program 307b are not initially stored in the hard disk device 307. For example, each program is stored, in advance, in a portable physical medium, such as a flexible disk (FD), a CD-ROM, a DVD disk, a magneto-optical disk, an IC card, and the like, which is inserted in the computer 300. The computer 300 may be configured to read and execute the first encoding program 307a and the second encoding program 307b.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer readable storage medium that stores a coded data generation program that causes a computer to execute a process comprising:
obtaining a plurality of images, generated based on a same original image, having different resolutions;
determining a specified configuration for coding a specified image that is one of the plurality of images; and
coding each of the plurality of images by using the specified configuration.

2. The non-transitory computer readable storage medium according to claim 1, wherein
the specified image is a first image whose resolution is highest among the plurality of images; and
wherein the process comprises:
coding the first image before coding of the plurality of images other than the first image;
determining configuration for coding the first image; and
coding the plurality of images other than the first image by using the configuration for coding the first image.

3. The non-transitory computer readable storage medium according to claim 2,
wherein the configuration includes a plurality of configuration values for each of the coding units of image coding;
wherein a specified configuration value that is to be applied to a specified coding unit, among the coding units of the plurality of images other than the first image, is determined by integrating a specified configuration values applied to a plurality of coding units of the first image corresponding to the specified coding unit, sizes of coding units of the first image is smaller than sizes of coding units of the plurality of images other than the first image; and
wherein the process comprises:
coding the plurality of images other than the first image by using the determined configuration value included in the configuration.

4. The non-transitory computer readable storage medium according to claim 3,
wherein the configuration includes information that designates an Intra prediction mode or an Inter prediction mode for each of the coding units as the plurality of configuration values;
wherein, in the integrating, a prediction mode that is to be applied to the specified coding unit is determined based on a number or area of coding units to which the Intra prediction mode is applied, among the specified configuration values, or a number or area of coding units to which the Inter prediction mode is applied among the specified configuration values.

5. The non-transitory computer readable storage medium according to claim 3,
wherein the configuration includes information that indicates reference pictures for each of the coding units as the plurality of configuration values;
wherein, in the integrating, when reference pictures are different from one another among the specified configuration values, a reference picture that is the closest to image data that is to be a coding target is selected, among the specified configuration values, as the configuration value corresponding to the specified coding unit.

6. A coded data generation method comprising:
obtaining a plurality of images, generated based on a same original image, having different resolutions;
determining a specified configuration for coding a specified image that is one of the plurality of images; and
coding each of the plurality of images by using the specified configuration.

7. A coded data generation device comprising:
a memory; and
a processor configured to:
obtain a plurality of images, generated based on a same original image, having different resolutions;
determine a specified configuration for coding a specified image that is one of the plurality of images; and
code each of the plurality of images by using the specified configuration.
